(19) United States
(12) Patent Application Publication
(10) Pub. No.: US 2006/0057315 A1
(43) Pub. Date: Mar. 16, 2006

(54) Hermetically closed container and process for its manufacture

(76) Inventors: Robert Alois De Coninck, Aalst (BE); Johannes Lambertus Maria Mensink, Lier (BE); Emil Paul Bader JR., Cincinnati, OH (US); Guido Willem Meylemans, Blaasveld (BE); Gerard Laurent Philippe Buisson, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/268,942

(22) Filed: Nov. 8, 2005

Related U.S. Application Data
(63) Continuation-in-part of application No. 10/731,338, filed on Dec. 9, 2003.

(30) Foreign Application Priority Data
Jun. 14, 2001 (WO) PCT/US01/19245

(51) Int. Cl. B32B 27/10

(52) U.S. Cl. 428/34.2

(57) ABSTRACT

Disclosed is a hermetically closed container for packaging humidity sensitive solid food products, comprising a tube-shaped body made of a composite material comprising an outer coating, at least one outer cardboard layer, an oxygen barrier layer covering the cardboard layer on the inside, and an inner, heat-sealable coating of a thermoplastic material; a closure in the form of a sealed tear-off membrane comprising an oxygen barrier layer and an inner coating of a thermoplastic heat-sealable material; and a deep-drawn bottom made of a composite material comprising an outer varnish layer, at least one cardboard layer, an oxygen barrier layer covering the cardboard layer on the inside, and an inner coating of a heat-sealable thermoplastic material.

### RELATED APPLICATIONS

This application is a Continuation-in-Part of application Ser. No. 10/731,338, filed Dec. 9, 2003 which claims priority under 35 U.S.C. § 119(a) from PCT Application WO02102670A1 of De Coninck, et al. filed Jun. 14, 2001 which is herein incorporated by reference in its entirety.

### BACKGROUND OF THE INVENTION

The present invention relates to an improved high barrier package for food and non-food products, more particularly to a hermetically closed container for packaging humidity and oxygen-sensitive solid food products, which is capable to sustain a wide variety of atmospheric conditions and provides benefits in environmental aspects and in its overall manufacturing costs, and a process for its manufacture.

More specifically, the present invention relates to an improved hermetically closed container for packaging humidity and oxygen-sensitive solid food products, such as crisp food products, such as potato chips, processed potato snacks, nuts, etc., comprising a tube-shaped body made of a composite material comprising an outer coating, at least one outer cardboard layer, an oxygen barrier layer covering the cardboard layer on the inside, and an inner, heat-sealable coating of a thermoplastic material; a closure in the form of a sealed tear-off membrane comprising an oxygen barrier layer and an inner coating of a thermoplastic heat-sealable material; and a deep-drawn bottom made of a composite material comprising an outer varnish layer, at least one cardboard layer, an oxygen barrier layer covering the cardboard layer on the inside, and an inner coating of a heat-sealable thermoplastic material, the bottom with its rim being drawn upwards and outwards over the end face of the body and heat-sealed to the inside and the outside of the body.

Hermetically closed containers of this type are already known. For example U.S. Pat. Nos. 3,973,719 and 3,988,185 disclose a container assembly comprising a composite tubular body having an outwardly rolled top rim which body has an asymmetrically tabbed membrane-type closure sealingly secured to the rolled rim and a bottom made of metal sealed by crimping to the bottom end of the tubular body, and a method for its manufacture. Such container assemblies, however, are unsatisfying in view of their metal bottoms, which raise problems as far as manufacture, weight, costs and recycling are concerned.

Existing composite containers of this type available on the market are typically closed on one side with a metal end using the well-known (double-seam) seaming techniques. Metal ends, however, provide a relatively big part of the overall weight of the container, and therefore require a high energy and cause substantial emissions during manufacture. Furthermore, for waste recycling reasons, in a range of countries, the metal end needs to be separated from the rest of the package, causing an inconvenience for the consumer or the institutes responsible for waste recycling.

It is well-known that such metal ends or bottoms limit the use of these kind of packages in micro-wave ovens. In order to be able to heat the enclosed product in the container itself, and therefore increase the convenience for the consumer and the product range for these kind of packages, the metal end needs to be replaced by a micro-wave resistant material.

In trying to overcome such problems EP-A-O 352 127 discloses an oxygen barrier laminate structure suitable for producing an oxygen impermeable leak free container comprising a mechanically stable structural substrate, an outer layer of a heat-sealable polymer material, a first layer of a caulking polymer resin, an oxygen barrier material which can be selected from a wide range of material including aluminum foil, an extrusion coated inner heat-sealable product contactable polymer material and a sandwich layer of a second caulking polymer, an abuse-resistant polymer resin layer, a third caulking polymer resin, all coextruded in this sequence on the inner surface of the oxygen barrier material layer. However, the outer layer of the heat-sealable polymer material used therein is disadvantageous, in that it tends to discolor and dislocate during heat-sealing, i.e. sticks to the heat-sealing tool used with the high temperature necessary to provide for the desired high machine cycle times.

GB-A-2 176 457 describes a composite end closure member for a composite container, whose body comprises at least one outer cardboard layer, a barrier foil, e.g., of aluminum, covering the same on the inside, and an inner sealable plastic covering, whose closure comprises an optionally tear-off layer with an inner sealable plastic covering and whose deep-drawn bottom to be fitted, following the introduction of the charge, comprises at least one cardboard layer, a metal barrier foil and a sealable plastic covering placed on the inside, the bottom with its rim being drawn upwards and outwards over the end face of the body and is sealed on the inside and outside to the body, wherein the metallic barrier foil of the bottom is arranged on the inside of the cardboard layer and is itself provided on the side with a plastic covering and wherein the bottom is sealed to the body by inductive high frequency.

This high frequency heating is stated to be required to provide for the same machine cycle times during manufacture as provided with known containers having a tin plate bottom. It is specifically referred to therein as well that when using a bottom comprising at least one cardboard layer, a metal barrier foil and a sealing plastic covering placed on the inside, the heat-sealing by means of heat exclusively supplied from the outside and thus not by means of inductive high frequency provides only for unsatisfyingly long cycle times.

However, the use of inductive high frequency heating for heat-sealing such composite bottom closures is unsatisfying not only with respect to the machine and operating costs but also requires a certain thickness of the barrier foil which restricts the necessary variation thereof.

Furthermore, when attaching such composite end closure members to the tube part of the body by drawing the rim of the bottom upwards and outwards over the end face of the body, pin holes, cuts or cracking of the barrier layer may occur, which cause that the container loses its hermetic closure and thus its barrier characteristics. This is of a problem specifically when packaging solid crisp food products, which not only deteriorate under the influence of humidity but which also degrade in the presence of oxygen. In the case of such pin holes, cuts or cracking of the barrier layers, serious product deterioration can happen during storage. Such effects may be increased when the package is transported under varying pressure conditions, which may cause an increased contact of the interior of the container with the surrounding atmosphere due to a wide variety of atmospheric conditions, such as extreme variations in temperature, humidity, and altitude. Such conditions may cause a significant pressure difference between the inside and the outside of the container. Due to these variations the container material and hence the barrier layers, are subject to strains which may be so strong that pin holes or crack formations may occur or, when already present after manufacture, such perforations may increase thus causing the package to lose its barrier characteristics.

Furthermore, due to the hermetic character, the package may have a high internal pressure at high altitudes, which may cause the package to bulge outwardly. Depending upon the shape of the package, this outward bulging may cause the package to show an unstable behavior on the shelf (i.e. wobbling and rocking), hence negatively influencing the purchase behavior.

In addition, the existing composite materials used for the manufacture of such composite containers and bottoms must have properties which allow high machine cycle times including supplying and forwarding the composite raw material in sheet form to and through the machinery used for cutting, deep-drawing and transporting of the composite bottoms and the likes, which requires a material withstanding such conditions and not causing machine interruptions, which may be caused by the sticking or slipping of the composite laminate because of the outer coating of thermoplastic material.

In addition thereto, after the cutting of the bottom the remaining material of the composite material, the so-called web, needs to be transferred in and/or out of the cutting equipment, where during this transfer the composite material used for forming the tube-shaped body tends to easily break, cause jams and hence influences the reliability of the system.

Similarly, during forming and also during conveying of the composite bottom, friction plays an important role. Too much friction during the forming operation (i.e. deep-drawing) may cause the barrier layer(s) to crack or to result in pin holes. Also, depending upon the conveying system used, e.g., air conveying, it has been found that too much friction may cause jams. In the heat-sealing operation the material is folded, heated and pressed in its final shape in order to form and close the package. Too much friction between the outer surface and the heated parts causes the material to fold and seal improperly, hence disturbing the quality and reliability of the operation and seal. On the other hand, insufficient friction will cause problems because the composite material will slip from the parts of the machinery used for its processing, which again causes interruptions of the manufacturing process, which is very unwelcome specifically when operating at short machine cycle times.

Furthermore, during the heat-sealing operation using heat exclusively supplied from the outside, the material may discolor and even cause burn marks on the outer resin coating which is necessary to protect the outside of the container from humidity, dirt etc. and which may carry printed information for the consumer. However, during the distribution and storage and usage of such containers it is important that they withstand a certain amount of moisture and are resistant against dirt or dust pick-up, which is necessary to improve consumer acceptance and convenience.

### SUMMARY OF THE INVENTION

It has been surprisingly found that the invention can be achieved a very specific composite material for the bottom of the container, having a defined laminate structure, comprising an outer varnish layer on the outer cardboard surface, providing a specific coefficient of friction, and providing the oxygen barrier with an abuse-resistant reinforcing carrier layer which combination prevents the formation of pin holes, cuts or cracking of the barrier layers during manufacture, even when applying substantial pressure under high heat when bending the rim of the bottom upwards and outwards over the end face of the body, and during storage and transportation. Furthermore, the application of a reinforcing carrier layer for the oxygen barrier layer allows for providing very thin barrier layers, such as an evaporated metal layer, preferably of aluminum.

### BRIEF DESCRIPTION OF THE DRAWINGS

FIG. 1 shows a schematic representation of a prior art container assembly;

FIG. 2a schematic partial cut view of a detail showing the joint where the body is joined with the bottom; and

FIG. 3 a schematic representation of the laminate structure of the composite material used for the bottom.

### DETAILED DESCRIPTION OF THE INVENTION

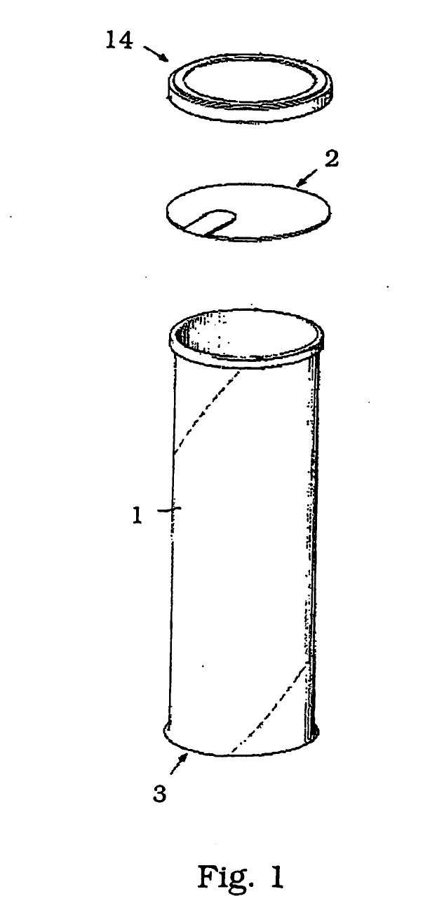

As shown in FIG. 1, prior composite containers comprise a composite tubular body (1) having an outwardly rolled top rim, a membrane-type closure (2) sealingly secured to the rolled ring so that the peripheral section of the closure conforms radially and circumferentially to an upwardly facing annular area of the rolled ring for the protection of the membrane and additional cap (14), and a bottom closure (not shown). The bottom closure (3) of such containers normally comprises a metal plate bottom attached by crimping to the tubular body. The tear-off membrane-type closure (2) may comprise a pull-tab to remove the membrane from the upper part of the body (1), which opening may thereafter be closed by the cap (14).

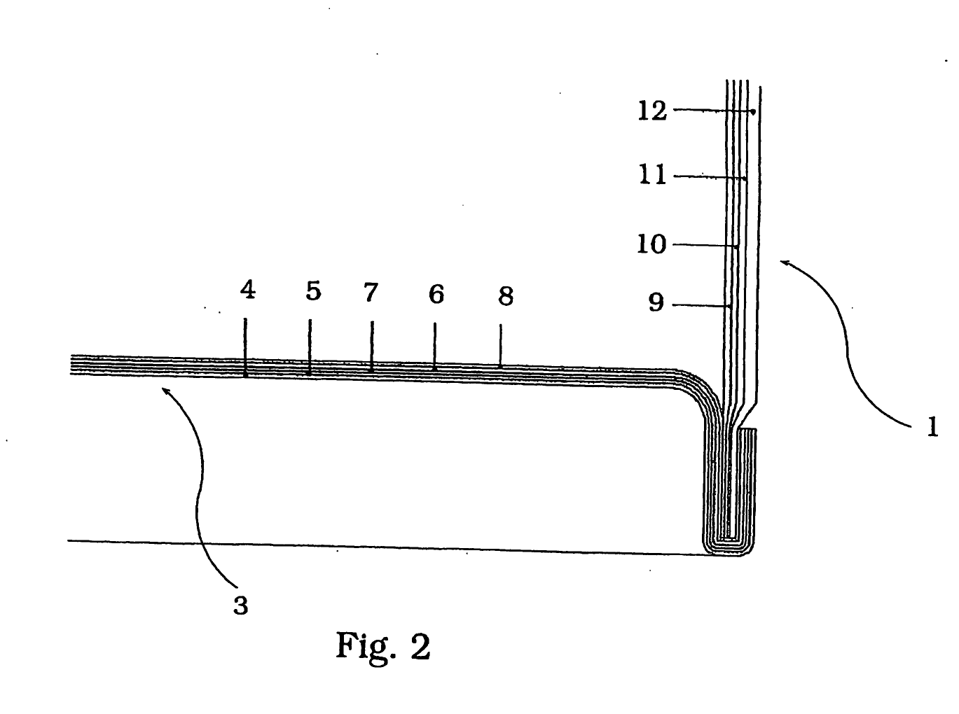

As in the prior art containers, the tube-shaped body (1) of the container of the present invention, which may not only be cylindrical as shown in FIG. 1 but may also be non-circular in cross section, e.g., triangular, quadrangular, pentagonal, hexagonal, is made by spirally or longitudinally winding a composite material. As can be seen from FIG. 2, the composite material used for the manufacture of the preferably cylindrical tube-shaped body (1) comprises an outer coating (12), at least one outer cardboard layer (11), an oxygen barrier layer (10), covering the cardboard layer on the inside and an inner, heat-sealable coating (9) of a thermoplastic material. The outside can be printed to provide information as to the content of the container.

The closure (2) normally comprises a thin membrane having one or more layers of paper, an oxygen barrier layer, preferably made of aluminum foil, or a polyethylene terephthalate film on which an aluminum layer has been evaporated, and an inner coating of a thermoplastic heat-sealable material. If necessary, adhesive layers may be provided between the paper, the barrier layer and the inner heat-sealable coating.

The present invention therefore comprises a hermetically closed container for packaging humidity-sensitive solid food products, comprising a tube-shaped body (1) made of a composite material comprising an outer coating (12), at least one outer cardboard layer (11), an oxygen barrier layer (10) covering the cardboard layer on the inside, and an inner, heat-sealable coating (9) of a thermoplastic material; a closure (2) in the form of a sealed tear-off membrane comprising an oxygen barrier layer and an inner coating of a thermoplastic heat-sealable material; and a deep-drawn bottom (3) made of a composite material comprising an outer varnish layer, at least one cardboard layer, an oxygen barrier layer covering the cardboard layer on the inside, and an inner coating of a heat-sealable thermoplastic material, the bottom with its rim being drawn upwards and outwards over the end face of the body (1) and heat-sealed to the inside and the outside of the body (1), which is characterized in that the composite material of the bottom (3) has a laminate structure comprising from the outside to the inside: a heat-resistant outer varnish layer (4) providing the coated cardboard surface with a coefficient of friction determined with an Instron apparatus according to the ASTM method D 1894-00 of between about 0.10 and about 0.45, preferably between about 0.20 and about 0.30, at least one cardboard layer (5), an oxygen barrier layer (6), an abuse resistant reinforcing carrier layer (7) for the barrier layer between the cardboard layer (5) and the oxygen barrier layer (6), and an inner heat-sealable coating (8) of a thermoplastic material.

It has been found that when covering the cardboard surface 6f the deep-drawn bottom (3) with an outer varnish layer (4) providing the coated cardboard surface with a coefficient of friction as defined above and attaching an abuse-resistant reinforcing carrier layer (7) for the barrier layer between the cardboard layer (5) and the oxygen barrier layer (6), all the above outlined problems can be solved in a very easy and elegant way. Namely, the formation of pin holes, cuts or cracking of the barrier layer can be prevented even in case the barrier layer comprises not a rather strong aluminum foil but only a reinforcing carrier layer (7), on which has been provided a continuous impermeable aluminum layer by evaporation.

Surprisingly, this laminate structure allows for the manufacture of the containers under consideration, wherein the bottom of the laminate structure with its rim is being drawn upward and outward over the end face of the body and heat-sealed to the inside and outside of the body (1) using a heated tool providing the necessary heat and pressure to not only shape the deep-drawn prefabricated body (1) around the lower rim of the tube-shaped body (1), but also to provide for the necessary heat-sealing, and using machine cycle times corresponding to those used during the manufacture of containers having a metal bottom presently on the market.

In addition thereto, the specified coefficient of friction provided by the outer varnish layer not only prevents protection against humidity, dirt or dust pick-up, but also allows for a desired coloration and/or the application of a text or pictures, but ensures the smooth handling of the material during the manufacture of the sheet material during the stamping, cutting and deep-drawing and removal of the materials remaining after stamping, i.e., the so-called web and their transportation in the conveying systems used. In addition, when using such a varnish layer, the discoloration and dislocation of the outer coating (12) of the body (1) can be prevented even when using a pressing tool for attaching the bottom to the rim of the tube-shaped body is at high temperatures of above 300 C and with very short machine cycle times, which do not allow for the cooling of the container and bottom being processed.

The hermetic closure or hermiticity of the container of the present invention is defined as the property of sustaining an oxygen (O₂) level inside the container corresponding to an average whole container oxygen transmission rate in air at ambient conditions of 23 C, 50% relative humidity and no absolute pressure differential between the outside and the inside of the container of less than 0.0002 ml O₂ per day and per cm² container surface.

According to a preferred embodiment of the present invention, the outer varnish layer (4) as shown schematically in FIG. 2 is resistant to discoloration and dislocation under the heat-sealing conditions applied. This means that there is neither browning nor attaching or sticking of the varnish to the tool used for the heat-sealing step. The heat-sealing conditions comprise a dwell time of 1.0 to 4.0 seconds, preferably 1.6 to 3.0 seconds, at a temperature ranging from about 120 C to about 280 C, and preferably from about 170 C to about 260 C and a pressure of the heat-sealing tool of from about 1 to about 22 MPa.

Preferably, the outer varnish layer (4) is provided by applying a heat-seal resistant primer, preferably an acrylic resin based primer. The primer may be applied by spraying, printing, dip-coating, curtain-coating, etc. More preferably the acrylic resin based primer comprises a styrenated acrylic resin. A preferred varnish of this type comprises a water-reducible composition comprising styrenated acrylic resins dispersed in a liquid medium comprising demineralized water, n-propyl alcohol and, if necessary, an anti-foaming and emulsifying agent.

The heat-seal resistant primer of the outer varnish layer (4) can be colored and/or with a pigment and as well can be provided on its surface with information provided either by printing, by laser engraving or the like. Preferably, the outer varnish layer (4) which can be applied in one or more layers is present in a total dry weight of from about 0.6 to about 1.8 g/m², and preferably from about 0.8 to about 1.2 g/m², on the cardboard layer (5).

According to a further preferred embodiment of the present invention, the oxygen barrier layers (6, 10) and that provided in the closure (2) are made of aluminum, more preferably of an aluminum foil or in the form of an aluminized coating on a carrier layer, such as the carrier layer (7) or a carrier layer used in the composite material forming the tube-shaped body (1). Such aluminum foils preferably have a thickness ranging from about 6 to about 12 μm, and preferably from about 7 to about 9 μm.

In case improved stability of the laminate structure is required, it is preferred to provide between the aluminum foil of the oxygen barrier layer (6, 10) and the surrounding layers, preferably the carrier layer (7) and the cardboard layer (12), an adhesive layer preferably comprising a polyethylene resin, preferably a low density polyethylene resin, a modified polyethylene resin containing vinyl acetate, acrylate and/or methacrylate monomers and/or an ethylene based copolymer having grafted functional groups.

Preferably, the abuse-resistant reinforcing carrier layer (7) is made of a tough, high strength polymeric material having a tensile strength measured according to ISO 1924 ranging from about 200 to about 500 N/I 5 mm, and preferably from about 350 to about 450 N/15 mm under the relevant heat-seal temperatures of from about 100 to 220 C. This “relevant” heat-seal temperature is the temperature the polymeric material will be subjected to during heat-sealing.

This carrier layer (7) preferably is made of a polyamide such as one of the many nylon-type materials, or a polyester resin, preferably polyethylene terephthalate or ethylene vinyl alcohol copolymers.

The cardboard layers (5, 11) can comprise one single layer or one or more sublayers joined by means of one or more adhesive layers. Preferably the cardboard layer (5) of the bottom (3) is present in a total area weight ranging from about 150 to about 450 g/m², more preferably from about 180 to about 340 g/m², whereas the cardboard layer (11) of the outer tube-shaped body (1) is present in a total area weight of from about 200 to about 600 g/m², and more preferably from about 360 to about 480 g/m².

The thermoplastic material used for the heat-sealable coating (8, 9) and of the closure (2) is heat-sealable at heat-seal temperatures ranging from about 90 C to about 200 C, and preferably comprises an ionomer-type resin, or is preferably selected from the group comprising salts, preferably sodium or zinc salts, of ethylene/methacrylic acid copolymers, ethylene/acrylic acid copolymers, ethylene/vinyl acetate copolymers, ethylene/methylacrylate copolymers, ethylene/methylacrylate copolymers, ethylene based graft copolymers and blends thereof. The outer coating (12) of the body (1) and the closure (2) can comprise a low density polyethylene, linear low density polyethylene, medium density polyethylene or mixtures thereof.

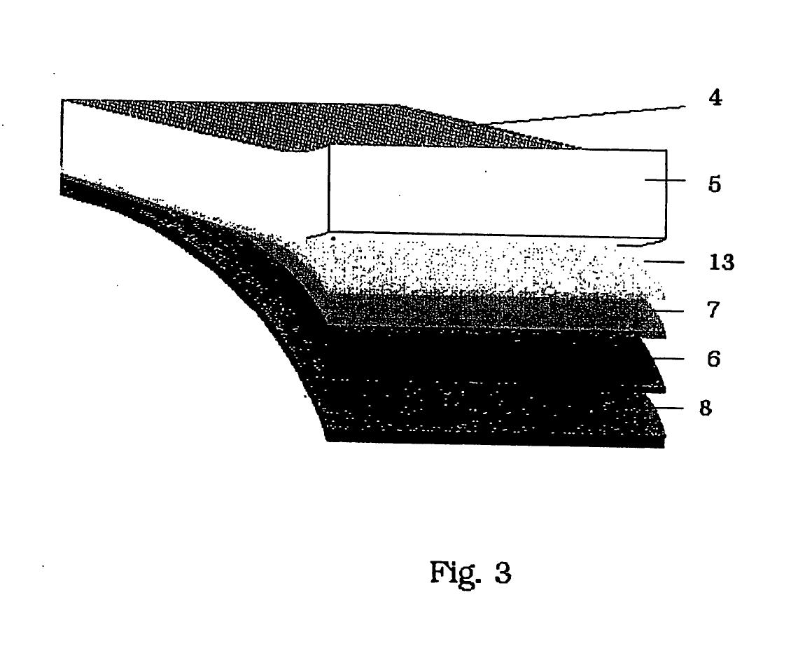

FIG. 3 shows a schematic representation of a preferred laminate structure of the composite material used for the manufacture of the deep-drawn bottom (3). This structure comprises a cardboard layer (5), which can comprise one layer or one or more sublayers joined by means of one or more adhesive layers, which cardboard layer (5) preferably comprises a 280 g/m² litho paper coated on the outside with a moisture barrier (4) and an overcoat lacquer, covering any imprint provided on the surface. Below the cardboard layer (5) an adhesive layer (13) is provided made of a low density polyethylene resin solidly attaching the abuse-resistant reinforcing carrier layer (7) made of polyethylene terephthalate. Attached to the other surface of the reinforcing carrier layer (7) is the oxygen barrier layer (6) made of aluminum foil which is provided on its inner surface with an inner heat-sealable coating (8) of an ionomer resin as defined above. If desired, an adhesive layer may be introduced between the oxygen barrier layer (6) and the inner heat-sealable coating (8).

A further embodiment of the present invention comprises the process for the manufacture of a hermetically closed container made from a composite material for packaging humidity-sensitive food products compositions comprising a tube-shaped body (1) made of at least one outer cardboard layer (9), an oxygen barrier layer (7) covering the cardboard layer on the inside, and an inner, heat-sealable coating of a thermoplastic material (6); a closure (2) comprising a sealed tear-off membrane comprising an oxygen barrier layer, and an inner coating of a thermoplastic heat-sealable material; and a deep-drawn bottom (3) comprising an outer varnish layer, at least one cardboard layer, an oxygen barrier layer covering the cardboard layer on the inside, and an inner coating of a heat-sealable thermoplastic material, the bottom with its rim being drawn upwards and outwards over the end face of the body (1) and heat-sealed to the inside and the outside of the body (1) characterized by heat-sealing the composite material of the bottom (3) having a laminate structure comprising from the outside to the inside: a heat-resistant outer varnish layer (4) providing the coated surface with a coefficient of friction determined with an Instron apparatus according to the ASTM method D 1894-00 of between about 0.10 and 0.45, preferably between about 0.20 and 0.30, at least one cardboard layer (5), an oxygen barrier layer (6), an abuse resistant reinforcing carrier layer (7) for the barrier layer between the cardboard layer (5) and the oxygen barrier layer (6), and an inner heat-sealable coating (8) of a thermoplastic material, using conductive heating by means of a pressing tool being heated to a temperature of above 300 C via the inner heat-sealable coating (8) to the inner, heat-sealable coating (9) and the outer coating (12) of the body (1).

Preferably, the process comprises heat-sealing using a dwell time ranging from about 1.0 to about 4.0 seconds, and preferably from about 1.6 to about 3.0 seconds, a temperature of between 120 C to about 280 C, and preferably from 170 C to about 260 C, and a pressure from about 1 to about 22 MPa.

The hermetic closure or hermiticity of the container prepared by the process of the present invention is defined as the property of sustaining an O₂-level inside the container corresponding to an average whole container oxygen transmission rate in air at ambient conditions of 23 C, 50% relative humidity and no absolute pressure differential between the outside and the inside of the container of less than 0.0002 ml O₂ per day and per cm² container surface.

The outer varnish layer (4) provided is according to a preferred embodiment of the process claimed resistant to discoloration and dislocation under the heat-sealing conditions applied.

The heat-sealing conditions under which the varnish layer (4) applied is resistant to discoloration, i.e. browning, and dislocation, i.e. sticking and assembling to the surface of the heat-sealing tool used, under heat-sealing conditions, comprising a dwell time of from about 1.0 to about 4.0 seconds, and preferably from about 1.6 to about 3.0 seconds, at a temperature ranging from 120 C to about 280 C, and preferably 170 C to about 260 C and a pressure of the heat-sealing tool of from about 1 to about 22 MPa.

Preferably, an outer varnish layer (4) is present which comprises a heat-seal resistant primer, preferably an acrylic resin based primer or preferably a primer comprising a styrenated acrylic resin. A preferred varnish of this type comprises a water-reducible composition comprising styrenated acrylic resins dispersed in a liquid medium comprising demineralized water, n-propyl alcohol and, if necessary, an anti-foaming and emulsifying agent. The varnish layer can either be colored and/or contain a pigment or may carry a written or picture information provided by printing or by laser engraving etc.

According to a preferred embodiment of the present invention the outer varnish layer (4) provided on the laminate structure used for the bottom (3) is provided to a dry weight of from about 0.6 to about 1.8 g/m², and preferably from about 0.8 to about 1.2 g/m², on the cardboard layer (5). Preferably, the oxygen barrier layers (6, 10) of the composite materials used are made of aluminum, more preferably of an aluminum foil or an aluminized coating on the carrier layer (7). The aluminum foil of the oxygen barrier layer (6, 10) and of the closure (2) has a thickness of from about 6 to about 12 μm, preferably 7 to 9 μm.

According to a further preferred embodiment of the present invention a laminate structure can be used for the manufacture of the deep-drawn bottom (3), which comprises an adhesive layer (13) between the aluminum foil of the oxygen barrier layer (6) and the carrier layer; or between the aluminum foil of the oxygen barrier layer (10) and the outer cardboard layer (11). The adhesive layers may comprise a polyethylene resin, preferably a low density polyethylene resin, a modified polyethylene resin containing vinyl acetate, acrylate and/or methacrylate monomers and/or an ethylene based copolymer having grafted functional groups.

Preferably, the laminate structure of the bottom (3) comprises an abuse resistant reinforcing carrier layer (7) made of a tough, high strength polymeric material having a tensile strength measured according to ISO 1924 of from about 200 to about 500 N/15 mm, and preferably from about 350 to about 450 N/15 mm under heat-seal temperatures of from about 100 to about 220 C. This “relevant” heat-seal temperature is the temperature the polymeric material will be subjected to during heat-sealing. More preferably, the carrier layer (7) is made of a polyamide or polyester resin, preferably polyethylene terephthalate or polybutylene terephthalate, or an ethylene vinyl alcohol copolymer.

The cardboard layers (5, 11) can comprise one single layer or one or more sublayers joined by means of one or more adhesive layers. Preferably the cardboard layer (5) of the bottom (3) is present in a total area weight ranging from about 150 to about 450 g/m², and more preferably from about 180 to about 340 g/m², whereas the cardboard layer (11) of the outer tube-shaped body (1) is present in a total area weight of from about 200 to about 600 g/m², and more preferably from about 360 to about 480 g/m².

According to a preferred embodiment of the present invention thermoplastic heat-sealable material is heat-sealable at heat-seal temperatures ranging from about 90 C to about 200 C and comprises an ionomer-type resin. Preferred ionomer-type resins are selected from the group comprising salts, preferably sodium or zinc salts, of ethylene/methacrylic acid copolymers, ethylene/acrylic acid copolymers, ethylene/vinyl acetate copolymers, ethylene/methylacrylate copolymers, ethylene/methylacrylate copolymers, ethylene based graft copolymers and blends thereof. Preferably, the body (1) used in the process of the present invention comprises an outer coating (12) of a low density polyethylene, linear low density polyethylene, medium density polyethylene or mixtures thereof.

The present invention thus provides for a hermetically closed container for packaging humidity- and oxygen-sensitive solid food products, preferably crisp carbohydrate-based, salted, crisp food products, such as potato chips, processed potato snacks, nuts, etc. and which provides the necessary hermetic closure under widely varying climate conditions of high and low temperature, high and low humidity and high and low pressure, which can be manufactured according to the process claimed in an easy low-cost process involving usual conductive heating technology and usual handling and operating machines, which container provides for high structural stability at low weight and easy recycling with low environment pollution.

In normal practice, the containers of the present invention are prefabricated comprising the closure (2) in form of the membrane covered with the overcap (14) and are filled from the open bottom side, whereafter the deep-drawn bottom (3) is sealed to the body (1) providing the seam on the bottom of the container.

All documents cited in the Detailed Description of the Invention are, in relevant part, incorporated herein by reference; the citation of any document is not to be construed as an admission that it is prior art with respect to the present invention. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A hermetically closed container for packaging humidity sensitive solid food products, comprising a tube-shaped body made of a composite material comprising an outer coating, at least one outer cardboard layer, an oxygen barrier layer covering the cardboard layer on the inside, and an inner, heat-sealable coating of a thermoplastic material; a closure in the form of a sealed tear-off membrane comprising an oxygen barrier layer and an inner coating of a thermoplastic heat-sealable material; and a deep-drawn bottom made of a composite material comprising an outer varnish layer, at least one cardboard layer, an oxygen barrier layer covering the cardboard layer on the inside, and an inner coating of a heat-sealable thermoplastic material, the bottom with its rim being drawn upwards and outwards over the end face of the body and heat-sealed to the inside and the outside of said body wherein said bottom has a laminate structure comprising from the outside to the inside: a heat-resistant outer varnish layer providing the coated cardboard surface with a coefficient of friction determined with an Instron apparatus according to the ASTM method D 1894-00 of between about 0.10 and 0.45, preferably between about 0.20 and 0.30, at least one cardboard layer, an oxygen barrier layer, an abuse resistant reinforcing carrier layer for the barrier layer between the cardboard layer and the oxygen barrier layer, and an inner heat-sealable coating of a thermoplastic material.

2. The hermetically closed container according to claim 1, wherein the hermetic closure corresponds to an average whole container oxygen transmission rate in air at a ambient conditions of 23 C, 50% relative humidity and no absolute pressure differential between the outside and the inside of said container of less than 0.0002 ml O₂ per day and per cm² container surface.

3. The hermetically closed container according to claim 1 such that the outer varnish layer is resistant to discoloration and dislocation under the heat-sealing conditions applied.

4. The hermetically closed container according to claim 2, wherein the outer varnish layer is resistant to discoloration and dislocation under heat-sealing conditions comprising a dwell time of from about 1.0 to about 4.0 seconds, at a temperature of about 120 C to about 280 C, and at a pressure of the heat-sealing tool of about 1 to about 22 MPa.

5. The hermetically closed container according to claim 1 such that the outer varnish layer comprises a heat-seal resistant primer.

6. The hermetically closed container according to claim 5 such that the acrylic resin based primer comprises a styrenated acrylic resin.

7. The hermetically closed container according to claim 5 such that the heat-seal resistant primer of the outer varnish layer is colored and/or contains a pigment.

8. The hermetically closed container according to claim 1 such that the outer varnish layer is applied to a total dry weight ranging from about 0.6 to about 1.8 g/m², preferably from about 0.8 to about 1.2 g/m², on the cardboard layer.

9. The hermetically closed container according to 1 such that the oxygen barrier layers are made of aluminum.

10. The hermetically closed container according to claim 9 such that the oxygen barrier layer comprises aluminum foil or an aluminized coating on the carrier layer.

11. The hermetically closed container according to claim 9 such that the oxygen barrier layer comprises aluminum foil.

12. The hermetically closed container according to claim 11 such that the aluminum foil of the oxygen barrier layer has a thickness ranging from about 6 to about 12 μm.

13. The hermetically closed container according to claim 1 such that an adhesive layer is provided between the aluminum foil of the oxygen barrier layer and the carrier layer.

14. The hermetically closed container according to claim 1 such that an adhesive layer is provided between the aluminum foil of the oxygen barrier layer and the outer cardboard layer.

15. The hermetically closed container according to claim 14 such that said adhesive layers comprise a polyethylene resin, a modified polyethylene resin containing vinyl acetate, acrylate and/or methacrylate monomers, and/or an ethylene based copolymer having grafted functional groups.

16. The hermetically closed container according to claim 1 such that the abuse resistant reinforcing carrier layer is made of a high strength polymeric material having a tensile strength measured according to Iso 1924 of 200 to 500 N/15 mm, preferably 350 to 450 NI 15 mm under the relevant heat-seal temperatures of 100 to 220° C.

17. The hermetically closed container according to claim 16 such that the abuse resistant reinforcing carrier layer is made of a polyamide or polyester resin.

18. The hermetically closed container according to claim 1 such that the cardboard layers comprise one layer or one or more sublayers joined by means of one or more adhesive layers, wherein the cardboard layer of the bottom is present in a total area weight ranging from about 150 to about 450 g/m², and more preferably from about 180 to about 340 g/m², whereas the cardboard layer of the outer tube-shaped body is present in a total area weight ranging from about 200 to about 600 g/m², and more preferably from 360 to about 480 g/m².

19. The hermetically closed container according to claim 1 such that the thermoplastic heat-sealable material is heat-sealable at heat-seal temperatures ranges from about 90 to about 200 C.

20. The hermetically closed container according to claim 19 such that the thermoplastic heat-sealable material of the heat-sealable coating comprises an ionomer type resin.

21. The hermetically closed container according to claim 20 such that the ionomer type resin is selected from the group consisting of salts, preferably sodium or zinc salts, of ethylene/methacrylic acid copolymers, ethylene/acrylic acid copolymers, ethylene/vinyl acetate copolymers, ethylene/methylacrylate copolymers, ethylene/methylacrylate copolymers, ethylene based graft copolymers and mixtures thereof.

22. The hermetically closed container according to claim 1 such that the outer coating of the body comprises low density polyethylene, linear low density polyethylene, medium density polyethylene or mixtures thereof.
